(19) United States
(12) Patent Application Publication
(10) Pub. No.: US 2019/0128510 A1
(43) Pub. Date: May 2, 2019

(54) HOLLOW LIGHTING SYSTEM

(71) Applicant: Antares Iluminacion, S.A.U., Ribarroja (Valenica) (ES)

(72) Inventor: Federico MARTINEZ WEBER, Ribarroja (Valencia) (ES)

(73) Assignee: Antares Iluminacion, S.A.U., Ribarroja (Valenica) (ES)

(21) Appl. No.: 16/096,342

(22) PCT Filed: Apr. 25, 2016
(86) PCT No.: PCT/ES2016/070304

§ 371 Date: Oct. 25, 2018

(51) Int. Cl. F21V 21/35; F21V 21/15; F21V 23/00; F21S 8/02; F21V 23/06

(52) U.S. Cl. CPC F21V 21/35; F21V 21/15; F21V 23/06; F21S 8/02; F21V 23/003

(57) ABSTRACT

The present invention relates to a recessed lighting system enabling the control of one or several lighting devices, either by switching them on and off, or by regulating the intensity of the light or by orienting and displacing the lightning devices along a rail, thus allowing obtaining the desired focusing while regulating the intensity of the light and setting the lighting device or devices in the desired position.

### OBJECT OF THE INVENTION

The present invention relates to a recessed lighting system enabling the control of one or several lighting devices, either by switching the same on and off, or by regulating the intensity of the light, or the orientation and displacement of said lighting devices along a rail.

The object of the present invention is a recessed lighting system which enables obtaining the desired focusing while regulating the intensity of the light and setting the lighting device or devices in the desired position.

### BACKGROUND OF THE INVENTION

Lighting systems enabling the integration of lighting devices in recesses in walls, ceilings or floors are known in the state of the art.

These systems may comprise a supporting structure extending in a longitudinal direction and forming an internal space, accessible via an opening, at least one functional unit that can be housed in the internal space of the supporting structure and comprising a lower surface on which electrical contacts and at least one lighting device equipped with a lighting means are disposed, and comprising electrical contacts attachable to the electrical contacts of the functional unit to maintain the lighting device connected to the functional unit.

The above systems present the drawback that it is necessary to dispose the functional unit within a supporting profile which must subsequently be inserted vertically into a supporting structure in order to couple the functional unit within the supporting structure.

On the other hand, the light conditions in closed spaces may vary in accordance with the different requirements of the same or with the existing daylight.

The above lighting systems cannot be adapted to said requirements; the lighting may therefore be insufficient and unsuited in particular areas of the closed spaces or at particular times. Furthermore, when said conditions change, it is necessary to proceed with the replacement of the lighting device or devices, thus increasing the costs associated with the maintenance of the lighting system.

The present invention resolves all the aforementioned drawbacks, enabling high versatility of the lighting system with regard to both the lighting conditions and the variability of the requirements of the closed spaces.

### DESCRIPTION OF THE INVENTION

The present invention relates to a recessed lighting system enabling the control of one or several lighting devices either by switching the same on and off, or by regulating the intensity of the light or the orientation and displacement of the same along a rail.

The recessed lighting system enables its desired focusing while regulating the intensity of the light and setting the lighting device or devices in the desired position.

The recessed lighting system comprises a supporting structure extending in a longitudinal direction and forming an internal space, accessible via an opening, at least one functional unit capable of being housed in the internal space of the supporting structure and comprising a lower surface on which electrical contacts and at least one lighting device equipped with a lighting means are disposed, and comprising electrical contacts attachable to the electrical contacts of the functional unit in order to maintain the lighting device connected to the functional unit.

The supporting structure further comprises a rail to which the lighting device is coupled.

The recessed lighting system further comprises a lighting device control unit which in turn comprises a microprocessor for the control of the lighting device, either by the turning on and off of the same, or by the regulation of the intensity of the light or the orientation and displacement of said lighting device through the rail.

The recessed lighting system further comprises a computer application which may be installed in a computer, a mobile telephone, a tablet or similar device.

The recessed lighting system further comprises a transmission means to enable the sending of a set of instructions from the computer application to the control unit.

The recessed lighting system further comprises an array of actuators and/or controllers which receive an array of commands sent from the control unit, based on the set of instructions sent from the computer application to the control unit, thus turning on or off the lighting device, the regulation of the intensity of the light or the orientation and displacement of said lighting device along the rail.

Preferably, the array of actuators and/or controllers comprises at least one first actuator or motor to perform the displacement of the lighting device along the rail, and optionally a second motor to perform the rotation of the lighting means of the lighting device, and a third motor to perform the tilting of the lighting means of the lighting device.

Preferably, the array of actuators and/or controllers comprises at least one controller for the regulation of the intensity of the light from the lighting means and/or for its turning on and off.

### BRIEF DESCRIPTION OF THE DRAWINGS

FIG. 1 shows a perspective view of the recessed lighting system of the present invention, depicting a lighting device with a lighting means which in this embodiment are a single lamp.

FIG. 2 shows a transversal cross-sectional view of FIG. 1.

FIG. 3 shows a perspective view of le lighting device of the recessed lighting system portrayed in FIG. 1.

FIG. 4 shows an elevational view of FIG. 3.

FIG. 5 shows a diagram of the computer application of the recessed lighting system of the present invention which may be installed in a computer, mobile telephone, tablet or similar device.

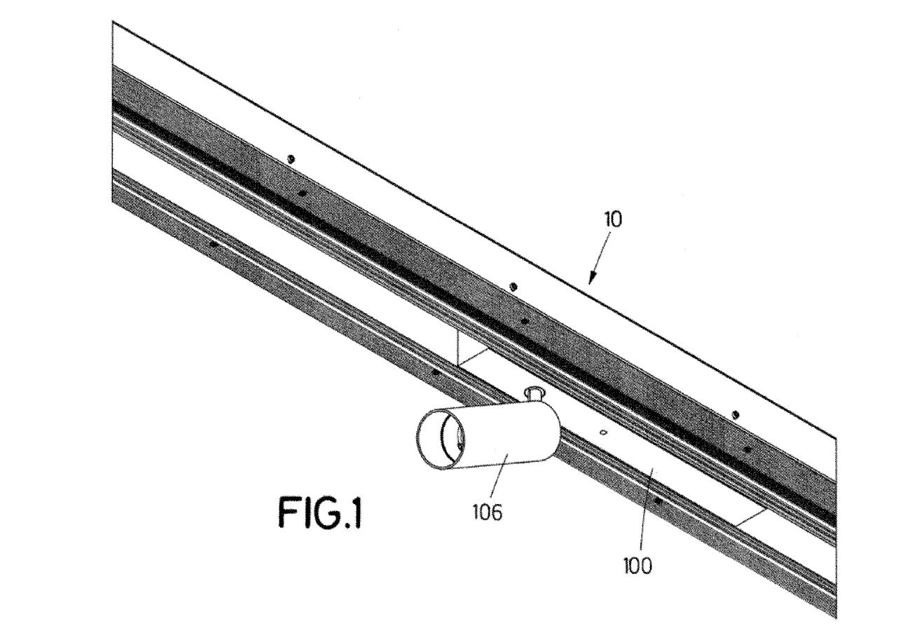

### PREFERRED EMBODIMENT OF THE INVENTION

The recessed lighting system of the present invention, applicable to a recess in a wall, ceiling or floor, is described in detail below.

The recessed lighting system comprises a lighting device (6) which may be totally housed within a supporting structure (10), or protrude partially or totally from the same (10).

The supporting structure 10) of the lighting system is preferably extruded, for example from aluminium, extending in a longitudinal direction (X) and forming an internal space (12), accessible via an opening (4) in said supporting structure (10).

Preferably, the shape of the supporting structure (10) is that of an inverted “U” and comprises two mutually facing lateral walls (14) defining two internal lateral surfaces (16), preferably flat and parallel, and a rear wall (18), linking the two mutually facing lateral walls (14) and closing the interior space (12) at its upper part.

The recessed lighting system further comprises a functional unit (40) attachable to the supporting structure (10), remaining entirely disposed within the internal space (12) of said supporting structure (10). The supporting structure (10) comprises an upper profile (42) where the functional unit (40) is housed, where said upper profile (42) comprises slots (43), in such a way that the functional unit (40) may be coupled to the upper profile (42) by means of the slots (43).

Furthermore, the functional unit (40) comprises a supporting plate (80) of an electrical connection, housed in the slots (43) existing in the upper profile (42) of the supporting structure (10), where said supporting plate (80) comprises electrical contacts (not shown) extending throughout the longitudinal direction.

Preferably, the supporting plate (80) of the electrical connection is comprised of a strip (not shown) of insulating material, for example silicon, and comprising a lower surface on which the electrical contacts (not shown) are arranged, to transmit the current and to regulate the intensity of the light from a lighting means (106) to be described below.

The supporting plate (80) of the electrical connection further comprises at least one electrical connector (90), disposed for example on the strip of insulating material, on the side opposite to that of the lower surface.

The electrical connector (90) of the supporting plate (80) of the electrical connection may be connected to a supply cable for the electrical connection of several functional units (40) to the control means of LED modules or to the main electricity supply.

The lighting system of the present invention further comprises a lighting device (6) for its coupling to the functional unit (40) and at the same time establishing an electrical connection with the electrical contacts extending throughout the longitudinal direction of the supporting plate (80) of the functional unit (40).

The supporting structure (10) further comprises a rail (101) to which the lighting device (6) is coupled, where said rail (101) is attached to the mutually facing lateral walls (14) of the supporting structure (10).

The recessed lighting system further comprises a lighting device (6) control unit (102) which in turn comprises a microprocessor (not shown) for the control of the lighting device (6).

The recessed lighting system further comprises a computer application (200) such as that shown in FIG. 5 or similar, which may be installed in a computer, mobile telephone, tablet or similar device, and a transmission means (not shown) to enable the sending of a set of instructions from the computer application (200) to the control unit (102).

The recessed lighting system further comprises an array of actuators (120, 130, 140) and/or controllers which receive an array of commands sent from the control unit (102), preferably via a wireless connection, based on the set of instructions sent from the computer application (200) to the control unit (102), thus to execute the turning on or off of the lighting device, the regulation of the intensity of the light or the orientation and displacement of said lighting device (6) along the rail (101).

In this example of an embodiment, the array of actuators (120, 130, 140) comprises three actuators which regulate the movement of the lighting device (6), where said three actuators are one first motor (120) which executes the displacement of the lighting device (6) along the rail (101), one second motor (130) which executes the rotation of the lighting means (106) of the lighting device (6), and one third motor (140) which executes the tilting of the lighting means (106) of the lighting device (6).

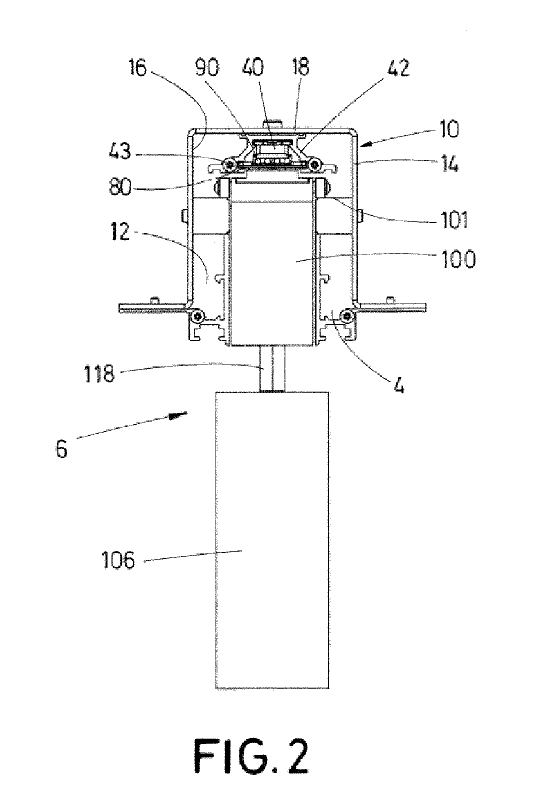

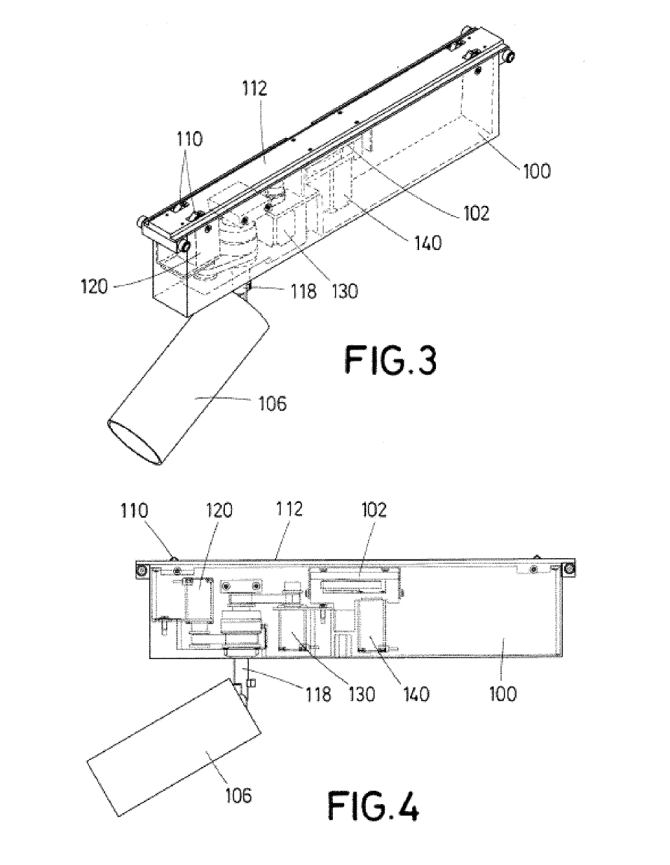

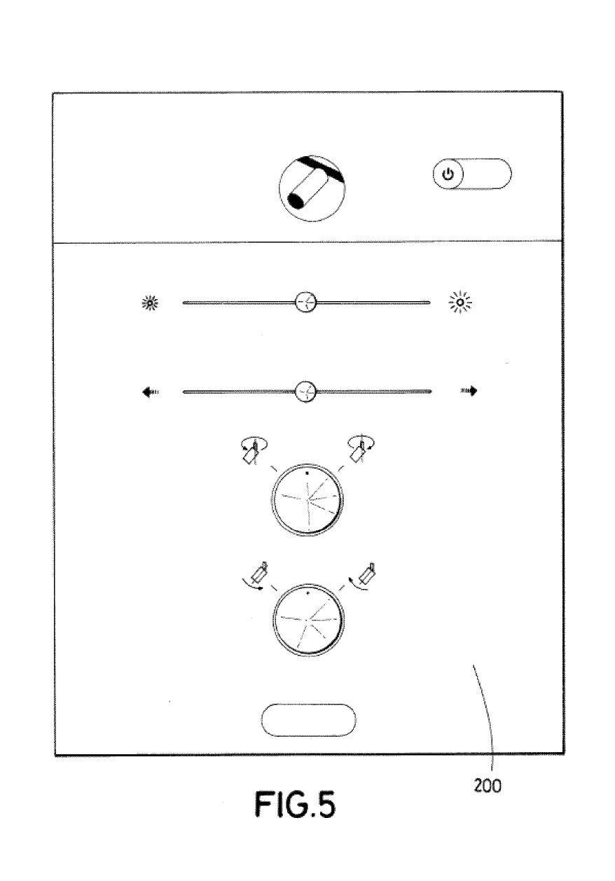

The lighting device (6) shown in FIGS. 2 and 3 comprises a housing (100) encasing the control unit (102), the array of actuators (120, 130, 140) and/or controllers and an array of mechanisms which transmit the movement of said array of actuators (120, 130, 140) and/or controllers to an arm (118) linking said array of mechanisms to the lighting means (106), and consequently transmitting the movements performed by the array of actuators (120, 130, 140) and/or controllers and transmitted by the control unit (102), based on the set of instructions sent from the computer application (200).

Furthermore, the lighting device (6) comprises electrical contacts (110) assembled on an electronic board (112) attached to the housing (100), suited to be coupled to the electrical contacts of the functional unit (40) in a sliding manner during the displacement of the lighting device (6) along the rail (101).

The array of actuators and/or controllers of the recessed lighting system further comprises a controller (not shown) for voltage regulation, for example from 1 to 10V and/or a pulse width modulation (PWM) system to regulate the intensity of the light from the lighting means (106) and its turning on and off.

1. A recessed lighting system for walls, ceilings or floors, comprising;
a supporting structure, extending in a longitudinal direction and forming an internal space;
at least one functional unit extending in a longitudinal direction and suited to be housed in the internal space of the supporting structure, and comprising a lower surface which comprises electrical contacts;
at least one lighting device equipped with a lighting means and comprising electrical contacts attachable to the electrical contacts of the at least one functional unit to maintain the at least one lighting device connected to the at least one functional unit;
wherein the supporting structure comprises a rail on which the at least one lighting device is coupled, and where the system further comprises:
a lighting device control unit which in turn comprises a microprocessor for the control of the at least one lighting device,
a computer application and means to allow the sending of a set of instructions from the computer application to the control unit,
an array of actuators and/or controllers which receive an array of commands sent from the control unit, based on the set of instructions sent from the computer application to the control unit, where the array of actuators comprises at least one first actuator or motor to perform the displacement of the at least one lighting device along the rail, and
wherein the at least one lighting device is comprised of a housing which encases the control unit, the array of actuators and/or controllers and as array of mechanisms which transmit the movement of said array of actuators and/or controllers to an arm linking said array of mechanisms to the lighting means, and consequently transmitting the movements performed by the array of actuators and/or controllers and transmitted by the control unit, based on the set of instructions sent from the computer application.

2. The system of claim 1, wherein the array of actuators further comprises a second motor to enable the rotation of the lighting means of the at least one lighting device, and a third motor to perform the tilting of the lighting means of the at least one lighting device.

3. The system of claim 1, wherein the array of actuators and/or controllers comprises at least one controller for the regulation of the intensity of the light from the lighting means and/or for its turning on and off.

4. The system of claim 1, wherein the shape of the supporting structure is that of an inverted “U” and comprises two mutually facing lateral walls defining two internal lateral surfaces and a rear wall, linking the two mutually lacing lateral walls and closing the interior space at its upper part.

5. The system of claim 4, wherein the supporting structure comprises an upper profile where the at least one functional unit is housed, where said upper profile comprises slots, in such a way that the at least one functional unit may be coupled to the upper profile by means of the slots.

6. The system of claim 5, wherein the at least one functional unit comprises a supporting plate of an electrical connection, housed in the slots existing in the upper profile of the supporting structure, where said supporting plate comprises the electrical contacts that extend throughout its longitudinal direction.

7. The system claim 6, wherein the supporting plate of the electrical connection further comprises at least one electrical connector

8. The system claim 4, wherein the rail, to which the at least one lighting device is coupled, is attached to the mutually facing lateral walls of the supporting structure.

9. (canceled)

10. The system of claim 1, wherein the electrical contacts of the at least one lighting device are assembled on an electronic board attached to the housing; these contacts couple in a sliding manner to the electrical contacts of the at least one functional unit during the displacement of the at least one lighting device along the rail.

11. A system of claim 1, wherein the array of commands is sent from the control unit to the array of actuators and/or controllers via a wireless connection.

12. The system of claim 2 wherein the array of actuators and/or controllers comprises at least one controller for the regulation of the intensity of the light from the lighting means and/or for its turning on and off.

13. The system of claim 2 wherein the shape of the supporting structure is that of an inverted “U” and comprises two mutually facing lateral walls defining two internal lateral surfaces and a rear wall, linking the two mutually facing lateral walls and closing the interior space at its upper part.

14. The system of claim 3 wherein the shape of the supporting structure is that of an inverted “U” and comprises two mutually facing lateral walls defining two internal lateral surfaces and a rear wall, linking the two mutually facing lateral walls and closing the interior space at its upper part.

15. The system of claim 13, wherein the supporting structure comprises an upper profile where the at least one functional unit is housed, where said upper profile comprises slots, in such a way that the at least one functional unit may be coupled to the upper profile by means of the slots.

16. The system of claim 14, wherein the supporting structure comprises an upper profile where the at least one functional unit is housed, where said upper profile comprises slots, in such a way that the at least one functional unit may be coupled to the upper profile by means of the slots.

17. The system of claim 15, wherein the at least one functional unit comprises a supporting plate of an electrical connection, housed in the slots existing in the upper profile of the supporting structure, where said supporting plate comprises the electrical contacts that extend throughout its longitudinal direction.

18. The system of claim 16, wherein the at least one functional unit comprises a supporting plate of an electrical connection, housed in the slots existing in the upper profile of the supporting structure, where said supporting plate comprises the electrical contacts that extend throughout its longitudinal direction.

19. The system of claim 17, wherein the at least one functional unit comprises a supporting plate of an electrical connection, housed in the slots existing in the upper profile of the supporting structure, where said supporting plate comprises the electrical contacts that extend throughout its longitudinal direction.

20. The system of claim 18, wherein the at least one functional unit comprises a supporting plate of an electrical connection, housed in the slots existing in the upper profile of the supporting structure, where said supporting plate comprises the electrical contacts that extend throughout its longitudinal direction.

21. The system of claim 19, wherein the at least one functional unit comprises a supporting plate of an electrical connection, housed in the slots existing in the upper profile of the supporting structure, where said supporting plate comprises the electrical contacts that extend throughout its longitudinal direction.
